(19) United States
(12) Patent Application Publication
(10) Pub. No.: US 2026/0201829 A1
(43) Pub. Date: Jul. 16, 2026

(54) GASEOUS FUEL COMBUSTION SYSTEM AND METHOD UTILIZING A PISTON REENTRANT FEATURE FOR HASTENED FUEL-AIR MIXING

(71) Applicant: Caterpillar Inc., Peoria, IL (US)

(72) Inventors: Chad P. Koci, Washington, IL (US); William Barnes, Rapid City, SD (US); Diego Bernardi Bestel, Naperville, IL (US); Bobby John, Peoria, IL (US)

(73) Assignee: Caterpillar Inc., Peoria, IL (US)

(21) Appl. No.: 19/024,592

(22) Filed: Jan. 16, 2025

(51) Int. Cl. F02B 23/10

(52) U.S. Cl. CPC F02B 23/104; F02B 2023/106; F02B 2275/48

(57) ABSTRACT

A piston includes a piston crown defining a center axis and having a piston rim extending around a combustion bowl. The combustion bowl includes an injection-impingement surface extending a first partial circumferential extent around the axis, a bowl floor extending to a bowl wall, and a reentrant surface positioned opposite the injection-impingement surface and extending a second partial circumferential extent around the center axis. The combustion bowl further forms a fluid dispersion path originating at the injection-impingement surface traversing the bowl floor and the bowl wall and extending to the reentrant surface. A gaseous fuel internal combustion engine and related methodology are also disclosed.

### TECHNICAL FIELD

The present disclosure relates generally to a gaseous fuel combustion system, and more particularly to enhanced mixing of a gaseous fuel with air in-cylinder utilizing surfaces of a non-axisymmetric piston.

### BACKGROUND

Internal combustion engines are widely used throughout the world for purposes ranging from vehicle propulsion to operation of pumps and compressors, to generation of electrical power. Typical internal combustion engines employ a plurality of pistons that reciprocate in cylinder bores to rotate a crankshaft in response to a controlled combustion reaction producing a rapid pressure and temperature rise to drive the pistons. For decades engineers have experimented with a wide variety of different fuels, various exhaust treatment apparatuses and technologies, and different operating strategies in efforts to improve engine operation, reliability, and performance.

In recent years considerable engineering resources have been directed at developing pistons optimized for various applications. Depending upon engine type, a piston is commonly formed with a specified combustion face geometry intended to interact with flows of fuel, air, and/or exhaust during operation to various ends including optimizing emissions and/or efficiency, to mitigate or otherwise control in-cylinder temperatures and/or mechanical wear or corrosion, and for various other purposes. It has been observed that oftentimes seemingly quite minor changes to piston geometry can have outsized effects upon engine operation and performance, and the results of toggling any one variable respecting piston geometry can often be quite unpredictable. Depending upon fuel type and a great many different operating parameters and different engine applications, optimized piston designs can have widely varying geometries. One known piston having a unique combustion face design is set forth in U.S. Pat. No. 11,828,220 to Zhang et al.

Compounding challenges around designing pistons for various different applications are recent commercial motivations to utilize alternative fuels. Many different piston designs for diesel engines, gasoline engines, and natural gas engines have been proposed. More recently, efforts at designing pistons optimized for hydrogen have begun in earnest. Combustion of hydrogen in an internal combustion engine brings many new challenges, as hydrogen tends to be easily ignited, and has a very rapid flame speed compared to certain traditional fuels, among other differences. While hydrogen engines and pistons optimized for combusting hydrogen have been proposed and some are now commercially available, many obstacles and opportunities for improvement and development of alternative strategies remain.

### SUMMARY

In one aspect, a gaseous fuel combustion system includes a piston defining a center axis and including a combustion bowl that is non-axisymmetric. The combustion bowl forms an injection-impingement surface extending around the center axis at a first location, and a reentrant surface extending around the center axis at a second location and connected to the injection-impingement surface. The combustion bowl further forms a fluid dispersion path advancing from the injection-impingement surface towards the reentrant surface. The gaseous fuel combustion system further includes a gaseous fuel injector oriented to target the injection-impingement surface with an injection of gaseous fuel.

In another aspect, a piston includes a piston crown defining a center axis and having a piston rim extending around a combustion bowl. The combustion bowl includes an injection-impingement surface extending a first partial circumferential extent around the center axis, a bowl floor extending to a bowl wall, and a reentrant surface positioned opposite the injection-impingement surface and extending a second partial circumferential extent around the center axis. The combustion bowl further forms a fluid dispersion path originating at the injection-impingement surface, traversing the bowl floor and the bowl wall and extending to the reentrant surface.

In yet another aspect, a method of operating a gaseous fuel internal combustion engine includes injecting a gaseous fuel into a cylinder in an internal combustion engine, and impinging the gaseous fuel upon an injection impingement surface of a non-axisymmetric combustion bowl of a piston reciprocated in the cylinder. The method also includes advancing the gaseous fuel in a fluid dispersion path across the bowl floor of the combustion bowl extending from the injection-impingement surface to a reentrant surface of the combustion bowl. The method further includes directing at least some of the gaseous fuel upwardly and inwardly via the reentrant surface so as to induce a tumbling flow promoting mixing of the gaseous fuel and air in the cylinder.

### BRIEF DESCRIPTION OF DRAWINGS

FIG. 1 is a diagrammatic view of a gaseous fuel combustion engine system, according to one embodiment;

FIG. 2 is a perspective view of a portion of the gaseous fuel combustion engine system, with additional components partially visible, according to another embodiment;

FIG. 3 is a sectioned perspective view of a piston, according to an embodiment;

FIG. 4 is a plan view of a piston of FIG. 3, according to an embodiment;

FIG. 5 is a plan view of a piston, according to an embodiment;

FIG. 6 is a sectioned side view of a piston in a combustion system, showing a diagrammatic representation of a fluid dispersion path, according to an embodiment;

FIG. 7 is a plan view of a piston, according to another embodiment;

FIG. 8 is a sectioned side view of a piston in a combustion system, showing a diagrammatic representation of the fluid dispersion path, according to another embodiment.

### DETAILED DESCRIPTION

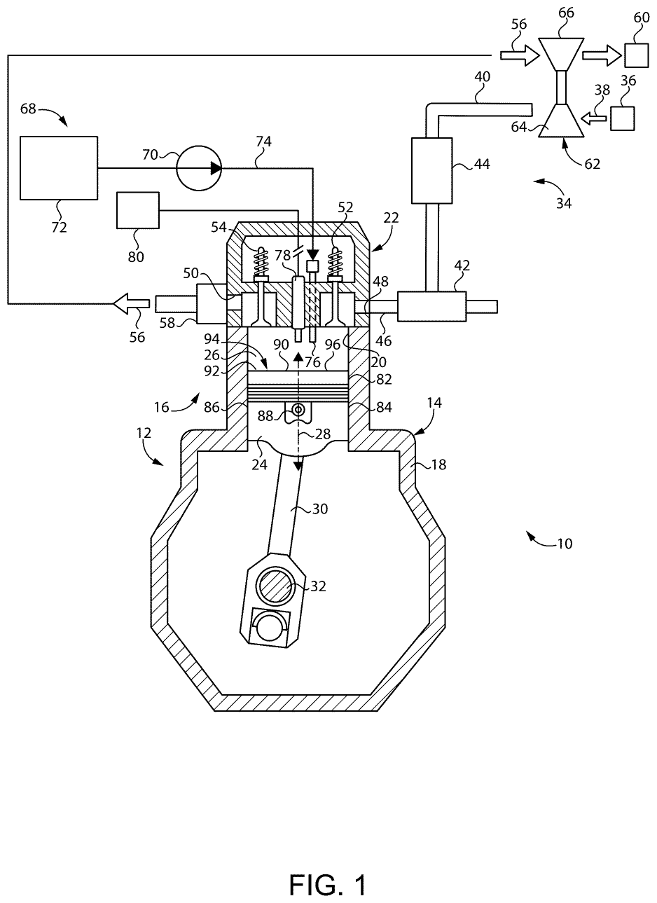

Referring to FIG. 1, there is shown an internal combustion engine system (hereafter “engine system 10), according to one embodiment. Engine system 10 can be applied in any known application, including operating a driveline in a land vehicle or a marine vessel, operating a pump, a compressor, or an electrical generator to name a few examples. Engine system 10 may include an engine 12 having an engine housing 14. Engine system 10 may also include a gaseous fuel combustion system 16 (“combustion system 16”). Combustion system 16 may include a cylinder block 18 forming a cylinder 20, and a cylinder head 22 attached to cylinder block 18. Cylinder 20 may be one of a plurality of cylinders of any number and in any suitable arrangement such as an in-line patten, a V-pattern, or still another. A piston 24 is movable in cylinder 20 between a top-dead-center position and a bottom-dead-center position, typically in a four-stroke engine cycle. It should be noted that piston 24 could be one of a plurality of pistons in a plurality of cylinders.

Engine housing 14, together with piston 24, forms a combustion chamber 26. During operation of engine 12, fuel and air are introduced and compressed within combustion chamber 26 prior to ignition. The combustion chamber may take a number of configurations, such as a flat roof configuration shown in FIG. 1, but is not limited to such. Piston 24 reciprocates following a path defined by a piston center axis 28. Combustion system 16 may also include a connecting rod 30 which rotates a crankshaft 32 in response to reciprocation of piston 24 in cylinder 20.

Engine 12 may also include an air system 34 having an air inlet 36 which forms an opening through which fresh air 38 is drawn into engine 12. Air 38 can pass through an intake conduit 40 which forms a passage toward an intake manifold 42, typically by way of a charge air cooler 44. In a practical implementation, engine 12 may include intake runners 46, which carry air to combustion chambers 26 of each cylinder 20. Cylinder head 22 may include an intake port 48 as well as an exhaust port 50, both fluidly connected to combustion chamber 26. An intake valve 52, typically one of two intake valves, is supported in engine housing 14 and is movable to fluidly connect intake conduit 40 to intake port 48.

Intake valve 52 may fluidly connect intake conduit 40 to combustion chamber 26. Engine 12 may further include an exhaust valve 54, typically one of two exhaust valves, moveable to fluidly connect exhaust port 50 to combustion chamber 26. Engine 12 also includes an exhaust conduit 56 extending from exhaust manifold 58 to an exhaust outlet 60. Air system 34 may also include a turbocharger 62 having a compressor 64 pressurizing the intake air and rotated by way of extracting energy from exhaust by way of a turbine 66.

Engine 12 may also include a fuel system 68 having a fuel pump 70, and a fuel supply 72. Fuel can be transported via a fuel supply conduit 74 to a fuel injector 76. Fuel supply 72 may contain a gaseous fuel, such as in a pressurized state. Embodiments of the present disclosure also contemplate fuel stored in a cryogenically liquefied state and/or fuel supplied by way of a gas line or the like (so-called “line gas”). Also in a practical implementation, the gaseous fuel may include a gaseous hydrogen fuel such as gaseous molecular hydrogen. Combustion system 16 may also be configured to operate on a blend of gaseous molecular hydrogen and a gaseous hydrocarbon fuel such as natural gas, methane, ethane, propane or still others. In further implementations combustion system 16 could be operated on substantially pure gaseous molecular hydrogen, solely a hydrocarbon gaseous fuel, or blends of hydrogen and hydrocarbon potentially supplied at a variable blend ratio. A gaseous hydrogen fuel as contemplated therein means a gaseous fuel where gaseous molecular hydrogen predominates by volume. It should be appreciated the present disclosure is not limited with respect to gaseous fuel type or composition.

Fuel injector 76 is shown arranged as a direct injector for directly injecting gaseous fuel into cylinder 20. Fuel injector 76 may be electrically actuated, such as solenoid actuated, and injects gaseous fuel at a desired injection timing. In some embodiments the injection timing may be prior to an intake valve closing timing in an engine cycle as further discussed herein. In other embodiments, fuel injector 76 could be configured as a port fuel injector arranged to inject gaseous fuel into intake port 48. In a practical implementation, the orientation of a gaseous fuel injector may be coordinated with the incoming air flow, such that fuel is injected in a coordinated manner with the incoming air flow entering combustion chamber 26. Put differently, the coordination of incoming air and gaseous fuel injection involves timing the fuel delivery in relation to the air entering combustion chamber 26 and piston 24 movement. Strategies for achieving this coordination may vary, such as adjusting timing of injections relative to intake valve events, modifying spray patterns and angles, and still others.

Engine 12 also includes a sparkplug 78 forming a spark gap in cylinder 20 for generating an electrical spark to ignite a mixture of gaseous fuel and air in-cylinder. Sparkplug 78 may be electrically connected to, and both energized and controlled by an electronic control unit or ECU 80. Sparkplug 78 might include an open sparkplug or a prechamber sparkplug, for example. Prechamber ignition strategies where a dedicated feed of a fuel is fed to a prechamber fluidly connected to cylinder 20 are also within the scope of the present disclosure.

Piston 24 may further include a piston crown 82 having a piston outer crown surface 84, and a piston skirt 86 forming a wrist pin bore 88, attached to piston crown 82. Piston crown 82 also includes a combustion face 90 oriented toward combustion chamber 26, and a planar piston rim 92 circumferentially extending around combustion face 90. Combustion face 90 forms a combustion bowl 94 having an inner bowl surface 96 therein. Combustion bowl 94 can be utilized to redirect fluids within combustion chamber 26.

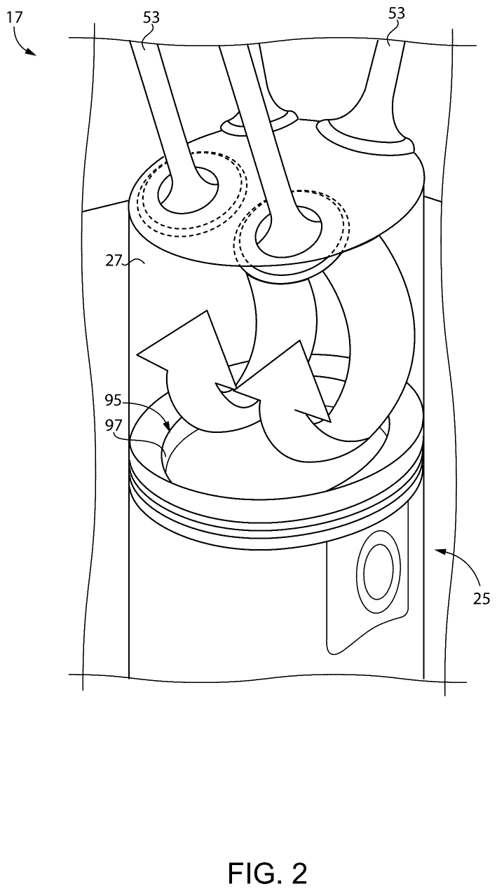

Referring now to FIG. 2, there is shown a portion of a combustion system 17, according to another embodiment. For clarity, the embodiment illustrated in FIG. 1 uses even reference numerals, while the embodiment illustrated in FIG. 2, uses odd reference numerals. Additionally, description of combustion system 16 applies to combustion system 17 by way of analogy, except as otherwise noted. For example, as mentioned above, combustion chamber 26 has a flat roof configuration, whereas combustion chamber 27 of the embodiment in FIG. 2 includes a pent roof configuration. Other differences are structural features of combustion bowl 95, which vary from combustion bowl 94, as further discussed herein. In the embodiment shown in FIG. 2, intake valve 53, in coordination with fuel injector 77, can be oriented to induce flow patterns within combustion chamber 27, such as a controlled tumble motion causing the fuel-air mixture to swirl in a rotational and/or a vortex or vortex-like motion.

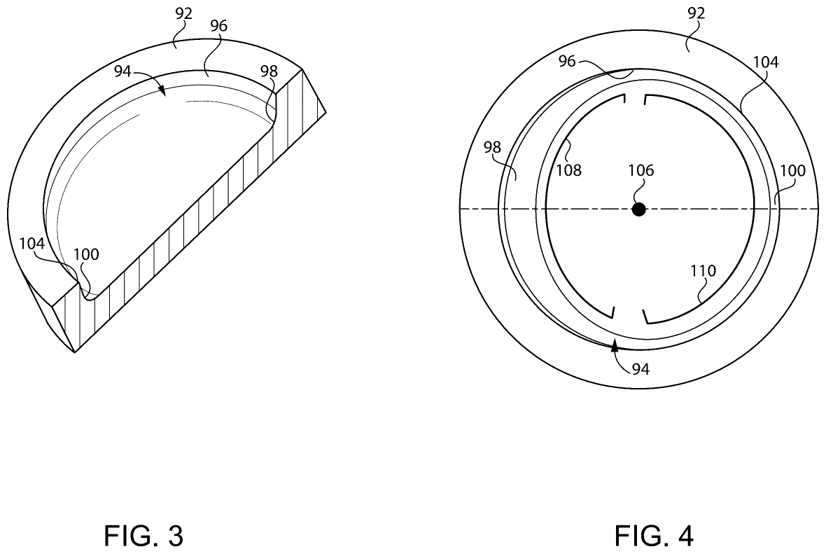

Referring also now to FIGS. 3 and 4, there are shown additional features of combustion bowl 94 for the embodiment shown in FIG. 1. Combustion bowl 94 includes an injection-impingement surface 98 extending along inner bowl surface 96. Injection-impingement surface 98 may be sloped radially inward, and axially downward, relative to piston axis 28. Combustion bowl 94 also includes a reentrant surface 100 extending along inner bowl surface 96 and connected to injection-impingement surface 98. Injection-impingement surface 98 may circumferentially extend around piston axis 28 at a first location and reentrant surface 100 may circumferentially extend around piston axis 28 at a second location positioned opposite to the first location.

As namely suggested, reentrant surface 100 redirects the trajectory of fluids introduced into combustion bowl 94. In a practical implementation, reentrant surface 100 utilizes momentum of a direct fuel injection to promote hastened mixing of fuel and air. In this example, fuel injector 76 may be oriented to target injection-impingement surface 100 with an injection of gaseous fuel, whereby at least some of the injected fuel is redirected upwardly and inwardly so as to promote fuel vortex generation for increased fuel-air mixing. Combustion bowl 94 further forms a fluid dispersion path 102 advancing from injection-impingement surface 100 towards reentrant surface 102, along which the injection of gaseous fuel travels, as further discussed herein. It should be appreciated that the direction and trajectory of fluid dispersion path 102 may vary depending on the relative positioning of injection-impingement surface 98 to reentrant surface 100.

Combustion bowl 94 also includes a perimetric bowl edge 104 positioned radially inward of piston rim 92 and defining a round shape having a geometric center point 106. The circular geometry may influence the extent to which injection-impingement surface 98 and reentrant surface 100 extend around piston axis 28. To this end, injection-impingement surface 98 may extend a first partial circumferential extent around piston axis 28 forming a first circular arc 108, and reentrant surface 100 may extend a second partial circumferential extend around piston axis 28, forming a second circular arc 110. First circular arc 108 may extend a lesser extent around piston axis 28 than second circular arc 110, but is not limited to such. In a practical implementation, second circular arc 110 may be defined from about 90° to about 180° around piston axis 28. It should be noted that the term “about,” as used in the present discussion, is intended to mean generally or approximately, and refers to values that are within an acceptable tolerance as would be understood by a person of ordinary skill in the gaseous fuel combustion system arts. Put differently, “about” may mean within conventional rounding or another acceptable tolerance that would be understood by a person of ordinary skill in the gaseous fuel combustion system arts.

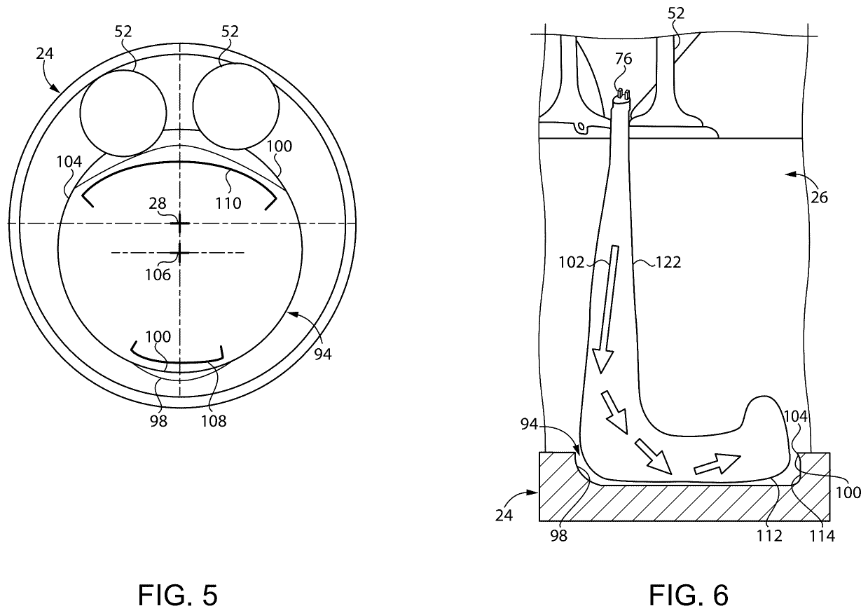

FIG. 5 illustrates an exemplary round shape for combustion bowl 94, corresponding to the embodiment of FIG. 1. As shown, combustion bowl 94 may be off-center relative to piston axis 28, and center point 106 is positioned radially outward of piston axis 28. However, center point 106 could be arranged to intersect piston axis 28. The circular geometry of each of the combustion bowls discussed herein may work in tandem with various combustion chamber designs. For instance, perimetric bowl edge 104 of combustion bowl 94 may form a symmetrical shape, such as a circular shape, to be used with the flat roof configuration of combustion chamber 26.

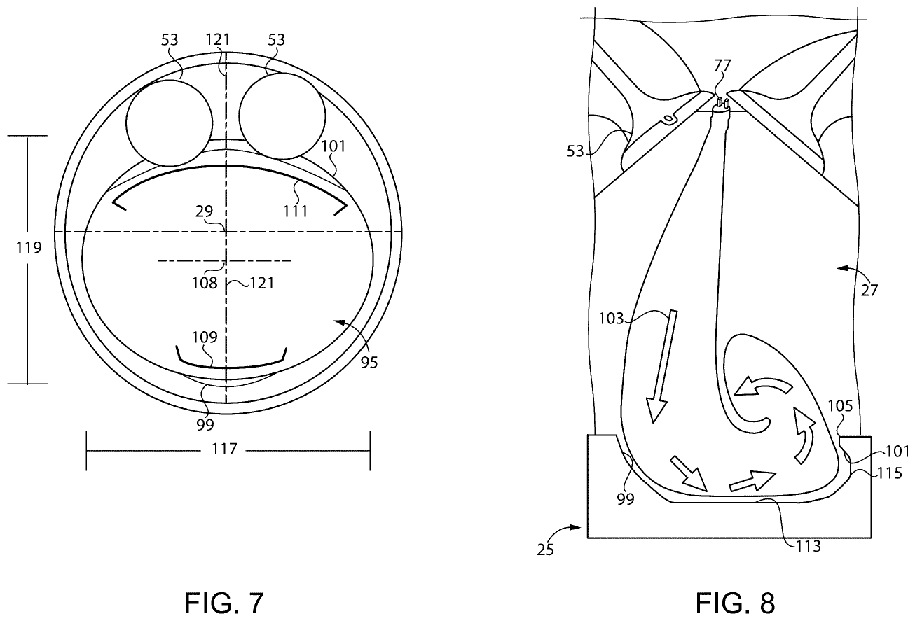

Referring also now to FIG. 7, illustrated is piston 24 during an injection event, according to the embodiment of FIG. 1. Combustion bowl 94 may include a bowl floor 112 located axially below both injection-impingement surface 98 and reentrant surface 100, at a location of piston axis 28. Bowl floor 112 extends from injection-impingement surface 98 and connects to reentrant surface 100 via a bowl wall 114. In this embodiment, bowl floor 112 may be planar at the location of center point 106. Additionally, reentrant surface 100 of combustion bowl 94 slopes axially upwardly and inwardly, toward piston axis 28 to form a sharp point at perimetric bowl edge 104. Bowl floor 112, bowl wall 114, and reentrant surface 100 may form, in profile, an elbow-like bend characterized by a smooth or curved transition.

Referring also now to FIGS. 7 and 8, shown is piston 25 corresponding to the embodiment of FIG. 2. The following description of combustion bowl 94 applies to combustion bowl 95 by way of analogy, except where specified otherwise. Combustion bowl 95 includes an inner bowl surface 97 having an injection-impingement surface 99 connected to a reentrant surface 101. Combustion bowl 95 may also form a fluid dispersion path 103 advancing from an injection-impingement surface 99 towards a reentrant surface 101. As noted above, the circular geometry of each of the combustion bowls discussed herein may work in tandem with various combustion chamber designs. To this end, combustion bowl 95 also includes a perimetric bowl edge 105 defining a round shape having a geometric center point 107. Injection-impingement surface 99 may form a first circular arc 109, and reentrant surface 101 may form a second circular arc 111, each extending around a piston axis 29. Combustion bowl 95 may also include a bowl floor 113 extending from injection-impingement surface 99 and connecting to reentrant surface 101 via a bowl wall 115.

Now turning to distinctions between combustion bowl 94 and combustion bowl 95, FIG. 8 illustrates piston 25 during an injection event, according to the embodiment of FIG. 2. Combustion bowl 95 includes bowl floor 113 which may be smooth and concave at the location of center axis 84. It should be appreciated that bowl wall 115 may also be curved and also formed to seamlessly blend together with bowl floor 113, creating a continuous surface. It should further be appreciated that reentrant surface 101 of combustion bowl 95 may form, together with perimetric bowl edge 134, a relatively smoother contour than combustion bowl 94 although the present disclosure is not thereby limited.

Additionally, as can be seen in FIG. 7, perimetric bowl edge 105 forms a round, shape, such as an oval. The oval shape may also define a major diameter 117, and a minor diameter 119 forming a geometric centerline 121 of fluid dispersion path 103. Additionally, combustion bowl may be non-axisymmetric, based on the different slopes and/or shapes of injection-impingement surface 99 and reentrant surface 101. Combustion bowl 95 may also be positioned generally off-center of piston axis 29 but is not limited to such. In a practical implementation, intake valve 53 of combustion chamber 27 may be oriented at an angle relative to piston axis 28, such that the positioning and angle of intake valve 53 assists with generating the tumbling effect.

### INDUSTRIAL APPLICABILITY

Referring to FIGS. 7 and 8, there are shown diagrammatic illustrations representing example gaseous fuel flow in-cylinder utilizing the geometry of the combustion bowls discussed herein. Each piston 24,25 and injected fuel is shown approximately as they might appear shortly after injecting gaseous fuel, such as before an intake valve closing timing in an engine cycle. Numeral 122,123 shows an outgoing fuel spray from fuel injector 76, in the course of traversing fluid dispersion path 102,103. When a gaseous fuel is injected, the fuel impinges upon an injection-impingement surface 98,99 of combustion bowl 94,95 and advances along fluid dispersion path 102,103. The gaseous fuel continues along its fluid dispersion path 102,103, traversing bowl floor 112,113 and bowl wall 114,115 extending to reentrant surface 100,101, where the gaseous fuel is redirected upwardly and inwardly via reentrant surface 100,101.

According to one embodiment, piston 25 may be employed in combination with a combustion chamber 27 having a pent roof configuration. Combustion bowl 95 can be employed to enhance charge motion in-cylinder for improved mixing of fuel by generating a tumbling effect to promote mixing of the gaseous fuel and air in the cylinder 21. In this embodiment, intake valves 53 can be positioned at an angle within the pent roof configuration, such that their orientations are angular relative to piston axis 28. This embodiment utilizes the angled intake valves 53 for air delivery in the pent roof configuration, which, in combination with combustion bowl 95 of piston 25, generates cooperative tumbling or rotational motion. Piston 24 operates under similar principles as piston 25, but the flat roof configuration may result in less or no cooperative effect between tumbling incoming air and the gaseous fuel flow.

In a practical implementation, operating a gaseous fuel internal combustion engine according to the present disclosure includes injecting the gaseous fuel into a cylinder in an internal combustion engine. Operating may also include impinging the gaseous fuel upon an injection-impingement surface of a non-axisymmetric combustion bowl of a piston reciprocated in the cylinder, and advancing the gaseous fuel in a fuel dispersion path across a bowl floor of the combustion bowl extending from the injection-impingement surface to a reentrant surface of the combustion bowl. Operating may further include directing at least some of the gaseous fuel upwardly and inwardly via the reentrant surface so as to induce a tumbling flow promoting mixing of the gaseous fuel and air in the cylinder. The mixed fuel and air can then be ignited by any suitable mechanism, such as spark ignition.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A gaseous fuel combustion system comprising:
a piston defining a center axis and including a combustion bowl that is non-axisymmetric, the combustion bowl forming an injection-impingement surface extending about the center axis at a first location, and a reentrant surface extending about the center axis at a second location and connected to the injection-impingement surface;
the combustion bowl further forming a fluid dispersion path advancing from the injection-impingement surface towards the reentrant surface; and
a gaseous fuel injector oriented to target the injection-impingement surface with an injection of a gaseous fuel.

2. The combustion system of claim 1 wherein the first location is opposite to the second location circumferentially around the center axis.

3. The combustion system of claim 1 wherein the combustion bowl further includes a bowl floor located axially below both the injection-impingement surface and the reentrant surface at a location of the piston center axis.

4. The combustion system of claim 3 wherein the bowl floor is planar at the location of the piston center axis.

5. The combustion system of claim 3 further comprising:
an engine housing forming, together with the piston, a combustion chamber having a pent roof;
an intake valve supported in the engine housing, and movable to fluidly connect an intake conduit to the combustion chamber; and
wherein the intake valve is oriented to generate tumble flow of incoming air through the intake conduit into the combustion chamber.

6. The combustion system of claim 5 wherein the orientation of the gaseous fuel injector is such that the injection of the gaseous fuel is coordinated with the tumble flow of incoming air.

7. The combustion system of claim 3 wherein the piston further includes a perimetric bowl edge forming a combustion bowl perimeter defining a geometric center point.

8. The combustion system of claim 7 wherein the combustion bowl perimeter includes a round shape, and the injection-impingement surface extends around the center axis a first partial circumferential extent, and the reentrant surface extends around the center axis a second partial circumferential extent.

9. A piston comprising:
a piston crown defining a center axis and including a piston rim extending around a combustion bowl, the combustion bowl including an injection-impingement surface extending a first partial circumferential extent around the center axis, a bowl floor extending to a bowl wall, and a reentrant surface positioned opposite the injection-impingement surface and extending a second partial circumferential extent around the center axis; and
the combustion bowl further forming a fluid dispersion path originating at the injection-impingement surface, traversing the bowl floor and the bowl wall, and extending to the reentrant surface.

10. The piston of claim 9 wherein the combustion bowl is non-axisymmetric about the center axis, and the injection-impingement surface is positioned opposite to the reentrant surface circumferentially around the center axis.

11. The piston of claim 9 further including a perimetric bowl edge positioned radially inward of the piston rim, the piston bowl edge defining a round shape having a geometric center point.

12. The piston of claim 11 wherein the round shape includes an oval shape, and the geometric center point is radially offset from the piston center axis.

13. The piston of claim 12 wherein the oval shape includes a major diameter and a minor diameter, and the minor diameter forms a geometric centerline of the fluid dispersion path.

14. The piston of claim 11 wherein the round shape includes a circular shape, and the geometric center point is intersected by the center axis.

15. The piston of claim 11 wherein the first partial circumferential extent is less than the second partial circumferential extent.

16. The piston of claim 15 wherein the second partial circumferential extent is from about 90° to about 180°.

17. The piston of claim 11 wherein the injection impingement surface slopes in a direction radially outward and axially upward relative to the center axis.

18. The piston of claim 17 wherein the bowl floor is concave at the location of the piston center axis.

19. A method of operating a gaseous fuel internal combustion engine comprising:
injecting a gaseous fuel into a cylinder in an internal combustion engine;
impinging the gaseous fuel upon an injection-impingement surface of a non-axisymmetric combustion bowl of a piston reciprocated in the cylinder;
advancing the gaseous fuel in a fuel dispersion path across a bowl floor of the combustion bowl extending from the injection impingement surface to a reentrant surface of the combustion bowl; and
directing at least some of the gaseous fuel upwardly and inwardly via the reentrant surface so as to induce a tumbling flow promoting mixing of the gaseous fuel and air in the cylinder.

20. The method of claim 19 wherein the gaseous fuel includes gaseous molecular hydrogen.
